(19) United States
(12) Patent Application Publication
(10) Pub. No.: US 2006/0126829 A1
(43) Pub. Date: Jun. 15, 2006

(54) Image encryption method

(76) Inventor: Binbin Lai, Fremont, CA (US)

Correspondence Address: Binbin Lai, P.O. Box 15268, Fremont, CA, 94539, US

(21) Appl. No.: 11/112,995

(22) Filed: Apr. 22, 2005

Related U.S. Application Data
(60) Provisional application No. 60/631,001, filed on Nov. 24, 2004.

(51) Int. Cl. H04L 9/28

(52) U.S. Cl. 380/28

(57) ABSTRACT

An image encryption method for protecting data security and privacy is provided. A preferred embodiment and several alternate embodiments of the invention are disclosed. The method comprises mapping from the original data to a sequence of random numbers and creating a cipherimage based on that, wherein the cipherimage is the encrypted image. Optionally, the method can comprise the disassembling and reassembling of the cipherimage. The method can comprise further transformations. As a result, the original data are encrypted and embedded into the cipherimage and the secure encryption is achieved. Though the preferred embodiment and some alternate embodiments of the invention are described in the context of image encryption, the application of the method can be extended to the encryption of various kinds of digital data.

### CROSS-REFERENCE TO RELATED APPLICATIONS

This application is a continuation-in-part application of Provisional Patent Application Ser. No. 60/631,011 entitled “ImageCipher system and methods for data security and privacy” filed on Nov. 23, 2004. This application claims the benefit of Provisional Patent Application Ser. No. 60/631,011 entitled “ImageCipher system and methods for data security and privacy” filed on Nov. 23, 2004 by the present inventor hereof.

### FEDERALLY SPONSORED RESEARCH

Not Applicable

### SEQUENCE LISTING OR PROGRAM

Not Applicable

### BACKGROUND OF THE INVENTION

1. Field of Invention

The present invention relates to the data security in general and to the image encryption in particular.

2. Prior Art

Under the background of protecting homeland security, many fingerprint images have been collected. It is predicted that more fingerprints will be collected upon the proposal of the use of the electronic passports featuring biometric data. The fingerprint data is considered one of the most important biometric data, and the protection of the fingerprint data privacy is important for people whose fingerprints either have been collected or will be collected. If the security of the fingerprint image data is compromised, then that not only endangers the privacy of the people whose fingerprints are in use, but also endangers the security of the homeland because the terrorists may obtain the digital fingerprint data through the use of the computer systems.

Currently, there are many systems that use biometric data such as the fingerprint images for authentication. However, the use of biometric data cannot guarantee the security of system unless the security of such data is guaranteed. Because the fingerprint images are often stored in the computer systems, they are subject to the evasion attacks by an unauthorized party with access to the computer networks. If such important data got lost into the hand of illegal party during an attack, then continually using the same data for the security protection will actually harm the system security. Because the biometric data cannot be changed like passwords, the protection of them is especially important.

For the above reasons, the security and privacy of the digital image data such as the fingerprint data must be protected in order to prevent them from being exploited by an unauthorized party especially the terrorist. The fingerprint images should be stored and transferred in encrypted format for the protection of security and privacy.

The traditional cryptography has been used for encrypting and decrypting messages. The message is disguised in a certain way to hide its substance in the process of encryption. The original message, which is called “plaintext” or “cleartext”, is encrypted into the ciphertext message after encryption. The encrypted message, which is called “ciphertext”, is translated back to the original plaintext message by the process of decryption. The common cryptographic methods, including the popular digital data encryption standard (DES), were designed for the protection of text messages but not for that of images. The prior art system and methods designed for the image encryption are not sufficient for protecting the security and privacy of the image data. At the time of the study, there is rarely a good solution for the secure encryption of the digital images to achieve the protection desired.

Meanwhile, as the computing power of the modem computer grows at a fast speed, there is a need to increase the data security so that the important data is not lost while being attacked by some very powerful computers.

Consequently, there is a need for an image cipher for encrypting the digital images so that the security and privacy of such important data can be protected and ensured.

### OBJECTS AND ADVANTAGES

The current invention has a significant advantage over the prior art in that the secure encryption of the image is achieved.

The method can be used for the secure storage and transfer of the fingerprint images. For security reasons, all the fingerprint data stored shall be in the encrypted format, so that the use of such information by any party for illegal purposes shall be prevented.

Besides the obvious advantage stated above, the present invention has some important objects and advantages:

(a) to provide an encryption method that is highly secure that can resist advanced cryptanalysis;

(b) to provide an encryption method that is flexible and can be used in different modes;

(c) to provide an encryption method that is versatile and can be applied to the encryption of various kinds of digital data;

(d) to provide an encryption method that is highly customizable and can allow users to make selections and changes;

(e) to provide an encryption method that is highly extensible and can be combined with some other methods for use.

### SUMMARY OF THE INVENTION

The invention presents an image encryption method for the protection of the security and privacy of the digital data especially the digital images.

Traditionally, the message to be encrypted is referred to as the plaintext while the encrypted message is referred to as the ciphertext. The same concepts will be used in the description of the various embodiments for encrypting the digital data other than image.

Corresponding to the “plaintext” and “ciphertext” concepts defined in traditional cryptography, the “plainimage” and “cipherimage” concepts are defined for the image cipher in the provisional patent application Ser. No. 60/631,011 entitled “ImageCipher system and methods for data security and privacy” filed on Nov. 23, 2004. The original image such as the fingerprint image, which is called “plainimage”, is disguised so that the party that intends to use the fingerprint data cannot recognize or extract the information hidden in the image. Accordingly, the encrypted image is called “cipherimage” which contains the information of the plainimage.

The invention describes a preferred embodiment and several alternate embodiments of the invention in detail.

The preferred embodiment of the present invention is described in the context of image encryption. The input is the plainimage wherein the plainimage is the original image such as the fingerprint image. The output is the cipherimage wherein the cipherimage is the encrypted image.

According to the preferred embodiment of the invention, the method comprises mapping from the original data to a sequence of random numbers and creating a cipherimage based on that, wherein the cipherimage is the encrypted image. As a result, the original data are encrypted and embedded into the cipherimage and the secure encryption is achieved.

Further, the method can comprise the disassembling and reassembling of cipherimage as described in one alternate embodiment. In the other alternate embodiment, the transformation of the cipherimage is described.

Though the preferred embodiment and some alternate embodiments of the invention are described in the context of image encryption, the application of the method can be extended to the encryption of various kinds of digital data as long as the data can be read as binary numbers. It will be appreciated that the method can be adopted by a variety of system and applications and can be used for the protection of various kinds of digital data.

### BRIEF DESCRIPTION OF THE DRAWINGS

The invention is herein described with reference to the accompanying drawings. With specific reference to the drawings in detail, it is stressed that the particulars shown are by way of examples and for purposes of illustrative description of the embodiments of the present invention, and are presented in the cause of providing what is believed to be the most useful and readily understood description of the principles and conceptual aspects of the invention. The drawings provided enable the fundamental understanding of the invention. The description and the accompanying drawings makes apparent to those skilled in the art how the several forms of the invention may be embodied in practice.

FIG. 1 is a block diagram describing the preferred embodiment of the image encryption method.

FIG. 2 is a flow chart depicting the step 1 of the preferred embodiment and the alterate embodiments, which is mapping from the data in the plainimage to a sequence of random numbers.

FIG. 3 is a flow chart depicting the step 2 of the preferred embodiment and the alternate embodiments, which is creating the cipherimage to embedded with the sequence of numbers the.

FIG. 4 is a block diagram describing the alternate embodiment 1 of the image encryption method.

FIG. 5 is a flow chart depicting the step 3 of the alternate embodiment 1, which is the disassembling and the reassembling of the cipherimage.

FIG. 6 is a block diagram describing the alternate embodiment 2 of the image encryption method.

FIG. 7 is a flow chart depicting the step 3 of the alternate embodiment 2, which is the transformation of the cipherimage.

### DETAILED DESCRIPTION OF THE INVENTION

### 1. DETAILED DESCRIPTION OF THE PREFERRED EMBODIMENT

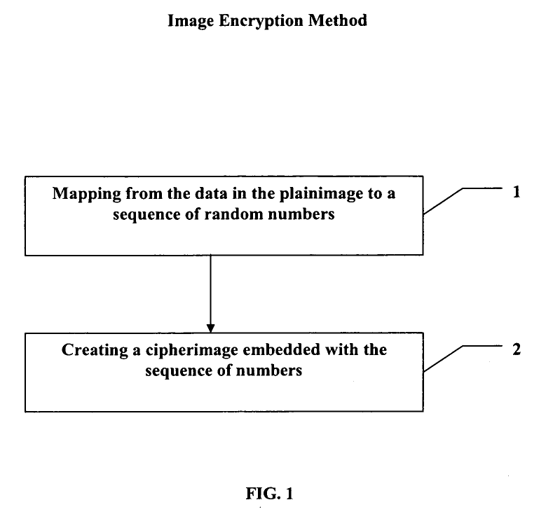

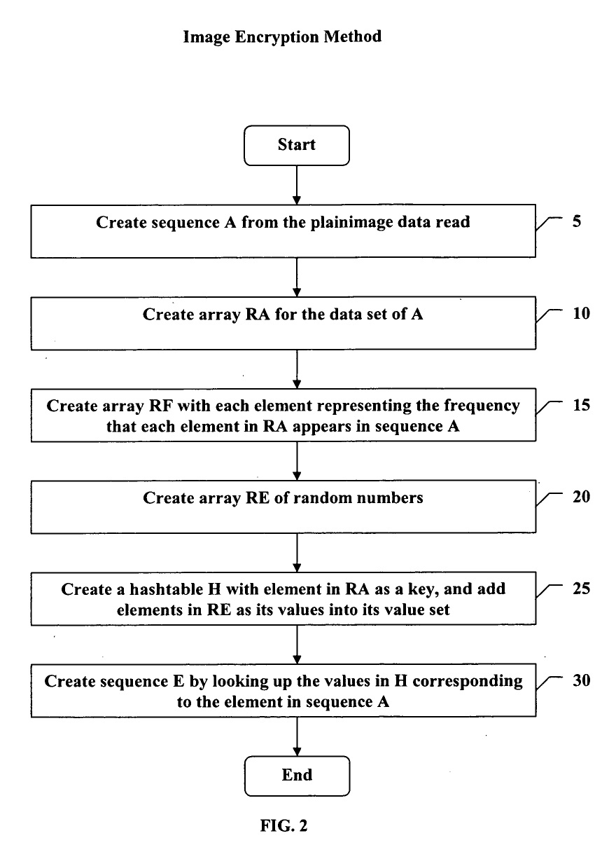

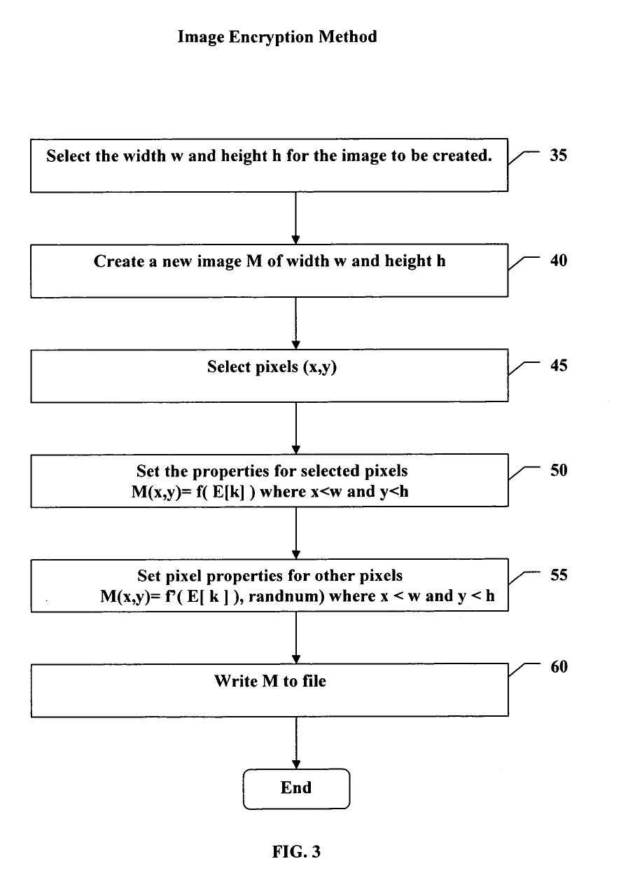

A preferred embodiment of the encryption method of the present invention is illustrated in FIG. 1, FIG. 2, and FIG. 3. FIG. 1 is the block diagram describing the preferred embodiment of the image encryption method. FIG. 2 is the flow chart depicting the step 1 of the preferred embodiment. FIG. 3 is the flow chart depicting the step 2 of the preferred embodiment.

According to FIG. 1, the preferred embodiment of the present invention comprises the mapping from the data in the plainimage to a sequence of random numbers and creating a cipherimage embedded with the sequence of numbers.

The mapping from the data in the plainimage to a sequence of random numbers is the first step of the preferred embodiment, which is illustrated in FIG. 2. The second step of the preferred embodiment is creating a cipherimage embedded with the sequence of numbers, which is illustrated in FIG. 3.

According to FIG. 2, the data in the plainimage is mapped to a sequence of random numbers. Firstly, a sequence is created from the plainimage data read. As a result, the plainimage data are stored in the sequence A as binary numbers. Secondly, an array is created for the data set of the sequence A. Thus the distinct elements of sequence A are stored in the array RA. Thirdly, an array is created for recording the frequency that each element in the array RA appears in the sequence A. Consequently, the elements in the array RF represent the frequencies that individual elements in the array RA appear in the sequence A. Fourthly, an array of random number is created. The array RE contains random numbers only. Fifthly, a hashtable is created for the mapping between the elements in the array RA and the elements in the array RE. The hashtable H is constructed by having each element in RA as a key and by adding the elements in RE as its values into its value set. Lastly, a sequence of random numbers is created by looking up the values in the hashtable H corresponding to the elements in the sequence A. Accordingly, the sequence E contains the random numbers from the array RE. At this point, the data in the plainimage are mapped to a sequence of random numbers completely.

According to FIG. 3, next a cipherimage is created to embed the sequence of numbers created from the previous step. Firstly, the width w and the height h shall be decided for the image to be created. Please note that the width w and the height h shall be properly selected so that the cipherimage to be created is not too small to hold the elements in the sequence E. Secondly, a new BufferedImage of the specified width w and the height h is created. The BufferedImage M is created for the cipherimage. Thirdly, the pixels are selected so that they can be used for encryption later. Fourthly, the properties of the selected pixels are set so that the encrypted data are embedded into the values of the pixel properties. Fifthly, the pixel properties of other pixels in M are set with values that are different from the numbers in the array RE. Lastly, the BufferedImage M is written to a file with its filename specified by the user and the creation of cipherimage is complete according to the preferred embodiment of the present invention.

The principles and operation of the method for the image encryption according to the present invention may be better understood with reference to the drawings and the accompanying description. Please note that all examples given are non-limiting illustrations of the invention described and defined herein.

In accordance with FIG. 2, firstly the plainimage data is read as binary numbers. It is reasonable to assume that all digital data can be read as binary numbers. A sequence of integers is constructed corresponding to that. The plainimage data read is thus stored in the sequence A. As a result, the sequence A contains all the original data in the form of integers. The length of the sequence A is dependent on the plainimage file read. Various graphical elements of the plainimage data, such as the lines, can also be represented as a number. For example, the line starting at (9,21) and ending at (32,69) can be represented as the number 1. Similarly, a circle with the center at (30,30) and the radius of 5 can be represented as the number 2. Other objects, such as triangles and rectangles can also be represented as numbers in this way.

In accordance with FIG. 2, next an array is created for the data set of the sequence A. The array RA is used to keep the elements in the data set. Each element in the array RA corresponds to an element in the data set of the sequence A and appears once and only once in the array RA. Let us assume that there are m elements in the array RA. Suppose that the plainimage has data and m is a positive integer.

In accordance with FIG. 2, after the array RA is created for the data set of the sequence A, an array is created to record the frequency that each element in the array RA appears in the sequence A. As a result, the array RF is constructed with its elements representing the frequencies that corresponding elements in the array RA appears in the sequence A. For example, if the element RF[i] has a value of 3, it means that the element RA[i] appears in the sequence A for 3 times. Please note that i is a non-negative integer which is no larger than the length of the array.

In accordance with FIG. 2, an array of random numbers shall be created next. The array RE contains a group of integers which are randomly generated. All the elements in the array RE forms a data set comprising the random numbers. Each element in the array RE shall appear once and only once. Let us assume that the array RE contains n random numbers. It shall be noted that the value of n shall be greater than or equal to the value of m, wherein m is the number of elements in the array RA. The random numbers in the array RE will be used for the viable mapping as described below.

In accordance with FIG. 2, a hashtable shall be created for the mapping between the elements in the array RA and the elements in the array RE once the array RE is created. The hashtable H is constructed by having each element in the array RA as a key and by adding the elements in the array RE as its values into its value set.

The hashtable H uses a one-to-one mapping between a key and its value set to represent the one-to-many relationship between its key and its values. It has been said that elements in the array RA are keys and the elements in the array RE are values.

An example is given below for the illustration of the one-to-many relationship between key and value represented in the one-to-one relationship between key RA[i] and value set {RE[j]} in hashtable H according to the present invention. Please note that i and j are index variables for the corresponding array elements. The following is a list of a few keys and corresponding value sets in the hashtable H. Please note that the value set is a group of the elements in the array RE.

| Key | Value set |
|---|---|
| RA[1] | {RE[17], RE[52], RE[39]} |
| RA[2] | {RE[61], RE[36]} |
| RA[3] | {RE[23]} |
| RA[4] | {RE[70], RE[15]} |
| RA[5] | {RE[41]} |
| RA[6] | {RE[57], RE[20]} |
| RA[7] | {RE[32], RE[69], RE[8]} |
| RA[8] | {RE[35]} |

Please note that each key of the hashtable H corresponds to a value set. Unlike the traditional use of the hashtable, which uses one-to-one mapping between the keys and values, the hashtable H uses one-to-one mapping between the key and the value set to represent the one-to-many relationship between the key and the values. It shall be noted that the number of members in the value set is decided based on the frequency that the key RA[i] appears in the sequence A. The more frequently the element in the array RA appears in the sequence A, the more random numbers in the array RE should be added to its value set in the hashtable H. This aspect of the invention improves the security of the method by changing the frequencies that individual codes appear in the cipherimage. Consequently, to the method of the invention can resist the cryptanalysis based on the frequency of appearance of the individual codes.

In accordance with FIG. 2, once the hashtable H is created for he mapping between the elements in the array RA and the elements in the array RE, a sequence of random numbers is created by looking up the values in the hashtable H corresponding to the elements in the sequence A. Accordingly, the sequence E contains the random numbers from the array RE.

Please note that the data set of the sequence A is contained in the array RA. It has been noted that the hashtable H has the elements in the array RA as its keys. Consequently, all the elements in the sequence A can be found in the key set of the hashtable H. As a result, the hashtable H allows the mapping between the elements in the sequence A and the elements in the sequence E by creating the mapping between the elements in the array RA and the elements in the array RE. It is preferred that one value is selected randomly from the values in the value set {RE[j]} when the actual mapping is performed so that the value in the array RE have even frequency of appearance in the sequence E.

At this point, all the elements in the sequence A are mapped to the elements in the sequence E and the data in the plainimage are mapped to a sequence of random numbers completely.

For the image encryption method, the hashtable H is the encryption key and can be considered as the decryption key as well. Because the keys of the hashtable are generated automatically based on the input data, and the values are the random numbers, the use of the hashtable as the encryption key makes the method of the invention very secure. Assume there are 1000 different integers in the data set of the sequence A, i.e., there are 1000 elements in the array RA and are mapped to the 1260 elements in the array RB with the hashtable H so that the frequency that each element in the array RB appears in the sequence E is even. To derive the plainimage based on the cipherimage is not quite possible, because there are more than

1000!=402,387,260,077,093,773,543,702,433,923,003,985,719,374,864,210,714,632, 543,799,910,429,938,512,398,629,020,592,044,208,486,969,404,800,479,988, 610,197,196,058,631,666,872,994,808,558,901,323,829,669,944,590,997,424, 504,087,073,759,918,823,627,727,188,732,519,779,505,950,995,276,120,874, 975,462,497,043,601,418,278,094,646,496,291,056,393,887,437,886,487,337, 119,181,045,825,783,647,849,977,012,476,632,889,835,955,735,432,513,185, 323,958,463,075,557,409,114,262,417,474,349,347,553,428,646,576,611,667, 797,396,668,820,291,207,379,143,853,719,588,249,808,126,867,838,374,559, 731,746,136,085,379,534,524,221,586,593,201,928,090,878,297,308,431,392, 844,403,281,231,558,611,036,976,801,357,304,216,168,747,609,675,871,348, 312,025,478,589,320,767,169,132,448,426,236,131,412,508,780,208,000,261, 683,151,027,341,827,977,704,784,635,868,170,164,365,024,153,691,398,281, 264,810,213,092,761,244,896,359,928,705,114,964,975,419,909,342,221,566, 832,572,080,821,333,186,116,811,553,615,836,546,984,046,708,975,602,900, 950,537,616,475,847,728,421,889,679,646,244,945,160,765,353,408,198,901, 385,442,487,984,959,953,319,101,723,355,556,602,139,450,399,736,280,750, 137,837,615,307,127,761,926,849,034,352,625,200,015,888,535,147,331,611, 702,103,968,175,921,510,907,788,019,393,178,114,194,545,257,223,865,541, 461,062,892,187,960,223,838,971,476,088,506,276,862,967,146,674,697,562, 911,234,082,439,208,160,153,780,889,893,964,518,263,243,671,616,762,179, 168,909,779,911,903,754,031,274,622,289,988,005,195,444,414,282,012,187, 361,745,992,642,956,581,746,628,302,955,570,299,024,324,153,181,617,210, 465,832,036,786,906,117,260,158,783,520,751,516,284,225,540,265,170,483, 304,226,143,974,286,933,061,690,897,968,482,590,125,458,327,168,226,458, 066,526,769,958,652,682,272,807,075,781,391,858,178,889,652,208,164,348, 344,825,993,266,043,367,660,176,999,612,831,860,788,386,150,279,465,955, 131,156,552,036,093,988,180,612,138,558,600,301,435,694,527,224,206,344, 631,797,460,594,682,573,103,790,084,024,432,438,465,657,245,014,402,821, 885,252,470,935,190,620,929,023,136,493,273,497,565,513,958,720,559,654, 228,749,774,011,413,346,962,715,422,845,862,377,387,538,230,483,865,688, 976,461,927,383,814,900,140,767,310,446,640,259,899,490,222,221,765,904, 339,901,886,018,566,526,485,061,799,702,356,193,897,017,860,040,811,889, 729,918,311,021,171,229,845,901,641,921,068,884,387,121,855,646,124,960, 798,722,908,519,296,819,372,388,642,614,839,657,382,291,123,125,024,186, 649,353,143,970,137,428,531,926,649,875,337,218,940,694,281,434,118,520, 158,014,123,344,828,015,051,399,694,290,153,483,077,644,569,099,073,152, 433,278,288,269,864,602,789,864,321,139,083,506,217,095,002,597,389,863, 554,277,196,742,822,248,757,586,765,752,344,220,207,573,630,569,498,825, 087,968,928,162,753,848,863,396,909,959,826,280,956,121,450,994,871,701, 244,516,461,260,379,029,309,120,889,086,942,028,510,640,182,154,399,457, 156,805,941,872,748,998,094,254,742,173,582,401,063,677,404,595,741,785, 160,829,230,135,358,081,840,096,996,372,524,230,560,855,903,700,624,271, 243,416,909,004,153,690,105,933,983,835,777,939,410,970,027,753,472,000, 000,000,000,000,000,000,000,000,000,000,000,000,000,000,000,000,000,000, 000,000,000,000,000,000,000,000,000,000,000,000,000,000,000,000,000,000, 000,000,000,000,000,000,000,000,000,000,000,000,000,000,000,000,000,000, 000,000,000,000,000,000,000,000,000,000,000,000,000,000,000,000,000,000, 000,000,000,000,000,000,000,000,000,000

possible mappings and the chance of deriving the decryption key is less than ( 1/1000!). It should be made evident that the method of invention provides secure protection of the digital image data.

In accordance with FIG. 3, the cipherimage is created to embed the sequence of data as the second step of the preferred embodiment. It is preferred that the sequence E is used as the input rather than the sequence A for improved security.

Please note that the width and height of the cipherimage can be selected by the user. The width and the height of the cipherimage are represented by the variable w and the variable h, respectively. It shall be noted that the multiple of w and h shall be greater than the length of the sequence E.

In accordance with FIG. 3, a new BufferedImage of the specified width w and the height h is created for the cipherimage. An example of using the Sun Java SDK to create the BufferedImage is shown as the following:
M=new BufferedImage(w,h)
Wherein M is the BufferedImage created for the cipherimage, w is the width variable of the image, and h is the height variable of the image.

In accordance with FIG. 3, next the pixels shall be selected, i.e., the values of the x and the y coordinates of the pixels shall be determined. The pixels can be selected in different ways. There are (n!/(m!(n−m)!)) possible selections if you want to select m pixels from the n pixels of the image wherein n and m are non-negative integers and m is less than n. It is preferred that the pixels are randomly selected. However, a pattern can be designed for the pixel selection. For example, the pixels in a certain triangles shall be selected if the triangle is the pattern. Any modification to the pattern of pixel selection, such as the changes to the shape and the size of the pattern, will affect how the encryption method works. Actually, any user-defined pattern can be used to customize the encryption method. It is preferred that the pattern is changed or updated frequently. Multiple patterns can be used together. For example, some pixels can be embedded in a line segment of the cipherimage, and some others can be embedded into a circle of the cipherimage. It shall be made evident that the flexibility of the pixel selection makes the encryption method more secure because there are many possible pixel selections available.

In accordance with FIG. 3, the pixel properties for the selected pixels shall be set once the pixels are selected. This is another highly customizable point of the encryption method of the present invention. Let M(x,y) represents the pixel properties of the pixel at the row x and the column y in the BufferedImage M which can consist of the values of the red, blue, and green color properties. Please note that it is possible to use the other properties of the image if preferred. According to the invention, the pixel properties shall be decided based on the value of the element of the sequence E, which can be represented as the following:
M(x,y)=f(E[k])
wherein x and y are coordinate variables and x<w and y<h, E[k] is an element in the sequence E, and f is a function that can be defined by the user or other party interested in using the method. Please note that the f function can represent any function. For example,
M(x,y)=3.E[k]+2
M(x,y)=(5.E[k]+1)(2.E[k]−2)
wherein x and y are coordinate variables and E[k] is an element in the sequence E. Please note that the change to the function f can produce a different encryption. It shall be evident that the method of invention is highly flexible and customizable.

In accordance with FIG. 3, next the pixel properties for the other pixels shall be set with the following function:
M(x,y)=f′(E[k],randnum)
wherein x and y are coordinate variables. Please note that x<w and y<h, E[k] is an element in the sequence E, randnum is a random number, and f′ can represent any function. The f′ function can be defined by the user or other party interested in using the method. Please note that the function f′ can be same or different with the function f.

In accordance with FIG. 3, at the end of the step 2 of the preferred embodiment, the BufferedImage M is written to file and the encryption is complete. At this point of step, the creation of the cipherimage is complete. It should be made evident that the encryption method of the invention is highly secure, customizable, and flexible.

### 2. DESCRIPTION OF THE ALTERNATE EMBODIMENT 1

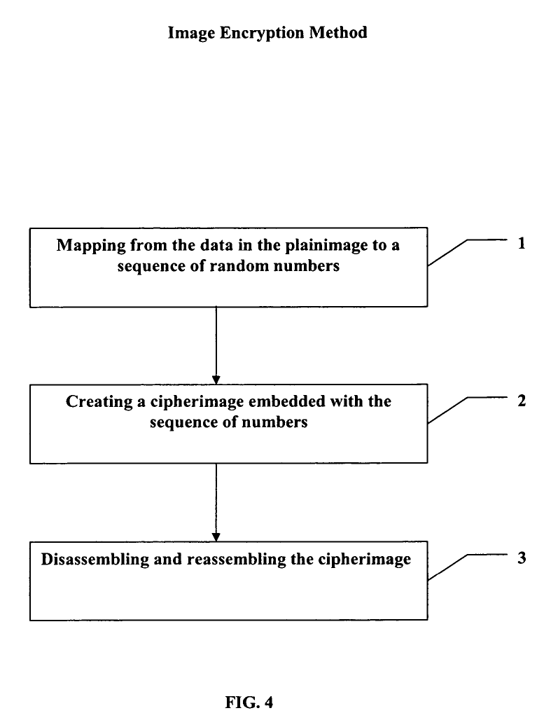

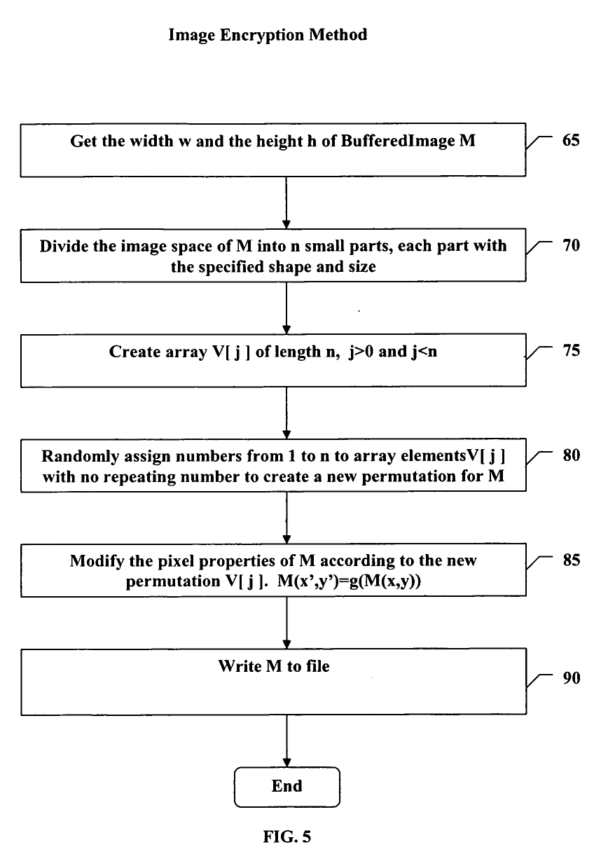

An alternate embodiment of the encryption method of the present invention is illustrated in FIG. 2, FIG. 3, FIG. 4, and FIG. 5. FIG. 4 is a block diagram describing the alternate embodiment 1 of the image encryption method. FIG. 2 is the flow chart depicting the step 1 of the preferred embodiment and the alternate embodiment. FIG. 3 is the flow chart depicting the step 2 of the preferred embodiment and the alternate embodiments. FIG. 5 is the flow chart depicting the step 3 of the alternate embodiment 1.

According to FIG. 4, the alternate embodiment 1 of the present invention comprises the mapping from the data in the plainimage to a sequence of random numbers, creating a cipherimage embedded with the sequence of numbers, and disassembling and reassembling of the cipherimage.

The mapping from the data in the plainimage to a sequence of random numbers is the first step of the alternate embodiment 1, which is illustrated in FIG. 2. The second step of the alternate embodiment 1 is creating a cipherimage embedded with the sequence of numbers, which is illustrated in FIG. 3. The third step of the alternate embodiment 1 is disassembling and reassembling of the cipherimage, which is illustrated in FIG. 5.

According to the alternate embodiment 1,the data in the plainimage is mapped to a sequence of random numbers as shown in FIG. 2. Firstly, a sequence is created from the plainimage data read. As a result, the plainimage data are stored in the sequence A as binary numbers. Secondly, an array is created for the data set of the sequence A. Thus the distinct elements of sequence A are stored in the array RA. Thirdly, an array is created for recording the frequency that each element in the array RA appears in the sequence A. Consequently, the elements in the array RF represent the frequencies that individual elements in the array RA appear in the sequence A. Fourthly, an array of random number is created. The array RE contains random numbers only. Fifthly, a hashtable is created for the mapping between the elements in the array RA and the elements in the array RE. The hashtable H is constructed by having each element in RA as a key and by adding the elements in RE as its values into its value set. Lastly, a sequence of random numbers is created by looking up the values in the hashtable H corresponding to the elements in the sequence A. Accordingly, the sequence E contains the random numbers from the array RE. At this point, the data in the plainimage are mapped to a sequence of random numbers completely.

According to the alternate embodiment 1, next a cipherimage is created to embed the sequence of numbers created as shown in FIG. 3. Firstly, the width w and the height h shall be decided for the image to be created. Please note that the width w and the height h shall be properly selected so that the cipherimage to be created is not too small to hold the elements in the sequence E. Secondly, a new BufferedImage of the specified width w and the height h is created. The BufferedImage M is created for the cipherimage. Thirdly, the pixels are selected so that they can be used for encryption later. Fourthly, the properties of the selected pixels are set so that the encrypted data are embedded into the values of the pixel properties. Fifthly, the pixel properties of other pixels in M are set with values that are different from the numbers in the array RE. Lastly, the BufferedImage M is written to a file with its filename specified by the user. At this point, the cipherimage has been created.

According to the alternate embodiment 1, the cipherimage is disassembled and reassembled in FIG. 5 for added security. Firstly, the width w and the height h of the BufferedImage M are got by

w=M.getWidth( ),

h=M.getHeight( )

if Sun Java SDK is used. Secondly, the image space of the BufferedImage, which is equal to the image space of the cipherimage, is divided into n small parts wherein n is a positive integer. Each part has a certain shape and size. The user can customize the encryption method by specifying different shape, size, and the cuts for the pieces. At this point, the cipherimage has been disassembled. Thirdly, an array of length n is created, which corresponds to the n pieces that the BufferedImage shall be divided into. The array V shall have n! permutations. Fourthly, the numbers from 1 to n are randomly assigned to the elements of the array V[j] so that a new permutation may be created. Fifthly, the pixel properties of M are modified according to the new permutation. This can be represented with a math formula
M(x′,y′)=g(M(x,y))
wherein x, y, x′, and y′ are coordinates and the g function is the relationship between the old pixel position and the new pixel position. Pleaset note that the g function depends on what the permutation is. Lastly, the BufferedImage M is written to file. At this point, the cipherimage has been reassembled.

It shall be noted that the step 3 of the alternate embodiment can further improve the security of the encryption method because of the pixel positions are changed after the disassembling and reassembling. The permutation of the pieces in the cipherimage will result in different arrangement of the pixels. For example, if the cipherimage is divided into 100 pieces, then there are up to 100! permutations. Consequently, there are up to

100!=93,326,215,443,944,152,681,699,238,856,266,700,490,715,968,264,381,621,4 68,592,963,895,217,599,993,229,915,608,941,463,976,156,518,286,253,697,9 20,827,223,758,251,185,210,916,864,000,000,000,000,000,000,000,000

different ways in which the cipherimage can be reassembled. Consequently, the cipherimage can have up to 100! different arrangement of pixels and the cryptanalysis is made difficult in this way. It shall be made evident that the alternate embodiment 1 enhances the security of the encryption method of the invention.

### 3. DESCRIPTION OF THE ALTERNATE EMBODIMENT 2

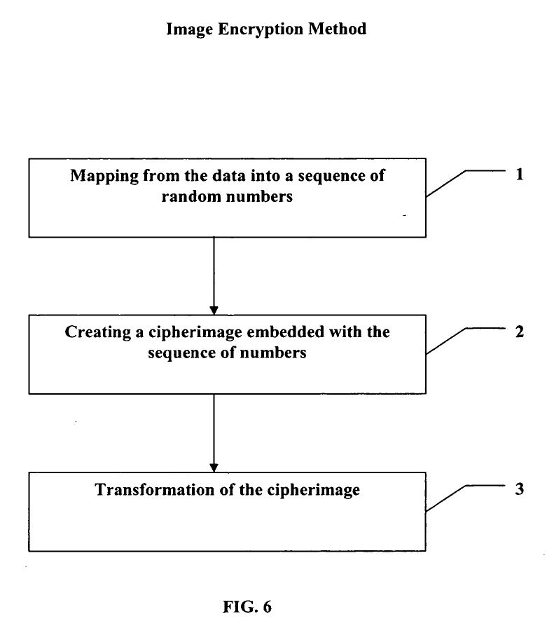

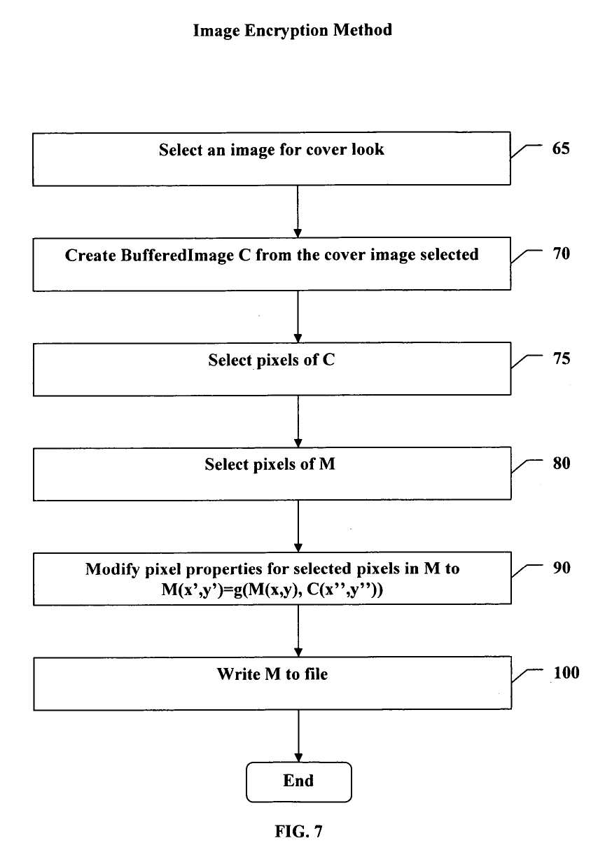

Another alternate embodiment of the encryption method of the present invention is illustrated in FIG. 2, FIG. 3, FIG. 6, and FIG. 7. FIG. 6 is a block diagram describing the alternate embodiment 2 of the image encryption method. FIG. 2 is a detailed flow chart depicting the step 1 of the preferred embodiment and the alternate embodiment. FIG. 3 is a flow chart depicting the step 2 of the preferred embodiment and the alternate embodiments. FIG. 7 is a detailed flow chart depicting the step 3 of the alternate embodiment 2.

According to FIG. 6, the alternate embodiment 2 of the present invention comprises the mapping from the data in the plainimage to a sequence of random numbers, creating a cipherimage embedded with the sequence of numbers, and transformation of the cipherimage.

The mapping from the data in the plainimage to a sequence of random numbers is the first step of the alternate embodiment 2, which is illustrated in FIG. 2. The second step of the alternate embodiment 2 is creating a cipherimage embedded with the sequence of numbers, which is illustrated in FIG. 3. The third step of the alternate embodiment 2 is the transformation of the cipherimage, which is illustrated in FIG. 7.

According to the alternate embodiment 2, the data in the plainimage is mapped to a sequence of random numbers as shown in FIG. 2. Firstly, a sequence is created from the plainimage data read. As a result, the plainimage data are stored in the sequence A as binary numbers. Secondly, an array is created for the data set of the sequence A. Thus the distinct elements of sequence A are stored in the array RA. Thirdly, an array is created for recording the frequency that each element in the array RA appears in the sequence A. Consequently, the elements in the array RF represent the frequencies that individual elements in the array RA appear in the sequence A. Fourthly, an array of random number is created. The array RE contains random numbers only. Fifthly, a hashtable is created for the mapping between the elements in the array RA and the elements in the array RE. The hashtable H is constructed by having each element in RA as a key and by adding the elements in RE as its values into its value set. Lastly, a sequence of random numbers is created by looking up the values in the hashtable H corresponding to the elements in the sequence A. Accordingly, the sequence E contains the random numbers from the array RE. At this point, the data in the plainimage are mapped to a sequence of random numbers completely.

According to the alternate embodiment 2, next a cipherimage is created to embed the sequence of numbers created as shown in FIG. 3. Firstly, the width w and the height h shall be decided for the image to be created. Please note that the width w and the height h shall be properly selected so that the cipherimage to be created is not too small to hold the elements in the sequence E. Secondly, a new BufferedImage of the specified width w and the height h is created. The BufferedImage M is created for the cipherimage. Thirdly, the pixels are selected so that they can be used for encryption later. Fourthly, the properties of the selected pixels are set so that the encrypted data are embedded into the values of the pixel properties. Fifthly, the pixel properties of other pixels in M are set with values that are different from the numbers in the array RE. Lastly, the BufferedImage M is written to a file with its filename specified by the user. At this point, the creation of cipherimage is complete.

According to the alternate embodiment 2, the transformation of the cipherimage is the third step as shown in FIG. 6. The transformation can change the look of the cipherimage. According to FIG. 7, firstly, a cover image should be selected. The pixels of the images will be used so that the cipherimage will look like the image selected. Secondly, a BufferedImage shall be created so that the pixels of the cover image can be retrieved. As a result, the BuffereImage C contains the pixels of the cover image. Thirdly, the pixels of the BufferedImage C shall be selected. It shall be noted that a subset of pixels rather than the whole set of pixels can be selected for later use. The selection of pixels has been described in the preferred embodiment and can be applied for the alternate embodiments. Fourthly, the pixels of the BufferedImage M shall be selected in the same way as described in the preferred embodiment. Fifthly, the pixel properties of the selected pixels in M shall be modified according to
M(x′,y′)=g(M(x,y),C(x″,y″))
wherein x,y,x′,y′,x″, and y″ are coordinate variables, g is a function which translates the previous pixel properties into the new pixel properties. Please note that the g function can represent any function, and can be defined by the user. These pixel positions can be same or different. For example,
M(x′,y′)=M(x,y)+C(x″,y″).
wherein x, y, x′, y′, x″, and y″ are coordinate variables, C(x″,y″) represents the pixel properties of the cover image at the point of (x″,y″), M(x,y) represents the pixel properties of the pixel at the position of (x,y) of the cipherimage created from the step 2, and M(x′,y′) represents the pixel properties of the pixel at the position (x′,y′) of the final cipherimage to be created in step 3. Lastly, the BufferedImage M is written to the file. At this point, the cipherimage has been transformed and given a new look.

According to the alternate embodiment 2, various transformation of the cipherimage can be used. For example, flipping of the image along the y=x line can be achieved by following the steps of the alternate embodiment 2 and by applying the function
M(x′,y′)=M(x,y)
wherein x, y, x′, and y′ are coordinate variables and x′=y and y′=x. Please note that M(x,y) represents the pixel properties of the cipherimage created from the step 2, and M(x′,y′) represents the pixel properties of the final cipherimage to be created in step 3.

According to the alternate embodiment 2, another example of the transformation is the reversal of the cipherimage, which can be achieved by following the steps of the alternate embodiment 2 and by using the function
M(x′,y′)=0xFFFFFF−M(x,y)
wherein x, y, x′, and y′ are coordinate variables and x′=x, y=y′. M(x,y) represents the pixel properties of the cipherimage created from the step 2, and M(x′,y′) represents the pixel properties of the final cipherimage to be created in step 3. It is assumed that the pixel properties consist of the red, green, and blue components and each has a value between 0 and 0xFF.

### 4. CONCLUSION, RAMIFICATIONS, AND SCOPE

From the description above, the advantages of my image encryption method shall become evident. According to the invention, the image encryption method can be used to protect the security and privacy of the image data. There are several modes to choose from, as shown in the preferred embodiment and the alternate embodiments of the invention.

The method of present invention can be used for the encryption of the fingerprint images, and can be further used for the secure data storage and data transfer. For security concern, all the fingerprint data to be stored in the fingerprint database shall be encrypted first, so that the use of such information by any party for illegal purposes shall be prevented. Before the transfer of fingerprint information, the fingerprint image shall be encrypted in a similar way as well. In this way, the image data stored and transferred are of no use to any unauthorized party who party who has attained the cipherimage and intends to use the fingerprint for illegal purposes.

Generally, the encryption method of the invention can be used to protect the security and the privacy of various kinds of digital data. The alternative embodiments provide some examples of the application of the method. However, the use of this method is not limited by the examples provided. Besides its application in the encryption of the digital images, the method can be applied to the encryption of other kinds of data including text messages, business data, and electronic documents. It will be appreciated that the application of the invention is not limited to the encryption of the image data. Actually, the encryption method of the invention can apply to various kinds of digital data as long as they can be read as binary numbers.

Furthermore, the present invention has the additional advantages in that

it provides a highly secure encryption method that can resist advanced cryptanalysis;

it provides an encryption method that is secure yet flexible;

it allows the choosing of modes according to the user requirements;

it provides a versatile encryption method that can be applied to the encryption of various kinds of digital data;

it provides an encryption method that is customizable and can allow users to make selections and changes;

it provides an encryption method that is highly extensible and can be combined with some other methods for use.

While this invention has been described in detail with reference to the embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention. The invention, therefore, is not to be restricted except in the spirit of the appended claims.

What is claimed is:

1. An image encryption method, comprising:
(a) mapping from the data in the plainimage to a sequence of random numbers, wherein the plainimage is the original image read from an input device;
(b) creating a cipherimage embedded with the said sequence of numbers, wherein the cipherimage is the encrypted image.

2. The method of claim 1 further comprises the disassembling and the reassembling of the said cipherimage.

3. The method of claim 1 further comprises the transformation of the said cipherimage.

4. An encryption method for the digital data, comprising:
(a) mapping from the original data to a sequence of random numbers;
(b) creating a cipherimage embedded with the said sequence of numbers, wherein the cipherimage is the encrypted image.

5. The method of claim 4 further comprises the disassembling and the reassembling of the said cipherimage.

6. The method of claim 4 further comprises the transformation of the said cipherimage.
